(19) United States
(12) Patent Application Publication
(10) Pub. No.: US 2002/0029152 A1
(43) Pub. Date: Mar. 7, 2002

(54) Method and apparatus for tracking mail items through a carrier distribution system

(75) Inventors: David K. Lee, Monroe, CT (US); Leon A. Pintsov, West Hartford, CT (US)

Correspondence Address: Steven J. Shapiro, Esq., Pitney Bowes Inc. - IP & TL Dept., 35 Waterview Drive, PO Box 3000, Shelton, CT, 06484, US

(73) Assignee: Pitney Bowes Inc., Stamford, CT (US)

(21) Appl. No.: 09/927,963

(22) Filed: Aug. 10, 2001

Related U.S. Application Data
(63) Continuation-in-part of application No. 09/703,231, filed on Oct. 31, 2000.
Application No. 09/703,231 is a continuation-in-part of application No. 09/339,768, filed on Jun. 24, 1999.

(51) Int. Cl. G06F 17/60

(52) U.S. Cl. 705/1; 705/401

(57) ABSTRACT

A carrier distribution system tracks a mail item having a unique sender generated identifier thereon. The carrier distribution system includes apparatus for reading the unique sender generated identifier from the mail item; structure for including a unique carrier generated identifier on the mail item; a data base that associates the unique sender generated identifier with the unique carrier generated identifier; at least one sensor that reads the unique carrier generated identifier from the mail item and provides location information to the data base that is associated with the unique carrier generated identifier so that at times when the carrier distribution system receives a location query from an entity about the mail item via submission of the unique sender generated identifier the location information is obtainable from the database without requiring submission of the unique carrier generated identifier by the entity.

### CROSS REFERENCE TO RELATED APPLICATIONS

This application is a continuation-in-part of U.S. Ser. No. 09/703,231 filed on Oct. 31, 2000 which is a continuation-in-part of U.S. Ser. No. 09/339,768 filed on Jun. 24, 1999. This application is also related to subject matter contained in U.S. Ser. No. 09/339,769 filed on Jun. 24, 1999 and United States Patent Application entitled “METHOD AND APPARATUS FOR TRACKING A SPECIAL SERVICE DELIVERY OF A MAIL ITEM CREATED BY AN OFFICE WORKER” filed on Aug. 10, 2001 and identified as Attorney Docket Number F-259.

### BACKGROUND OF THE INVENTION

Mail communication systems (for purposes herein such systems include postal services as well as private carrier services) are designed to provide for the delivery of physical mail items. These systems include mailers (senders of mail items), service providers (carriers and postal operators and their suppliers) and recipients. When a mailer sends a physical mail item (letter, flat, or parcel) he or she is typically interested in 1) knowing that the mail item has been delivered, 2) knowing the time of delivery and 3) in many cases having some (hopefully legally admissible) proof of delivery. Moreover, the mailer may also be interested in checking on the status of a yet to be delivered mail item particularly if there is some concern that the mail item may be lost. Traditional postal and carrier systems address this need by offering premium “track & trace” services. These traditional track and trace services assign a unique carrier generated number to each mail item which is used to track the mailpiece through the carrier distribution system. Confirmation of final delivery of the mail item is accomplished by either providing the sender with a physical document containing information about delivery or alternatively allowing the sender to access a web site of the service provider where the unique carrier generated number can be found if the mail item has been delivered. Additionally, inquiries regarding mail item tracking status are checked via the unique carrier assigned number.

One of the major problems of these traditional track and trace services is that the sender must go to the carrier's retail location to deliver the mail item personally in order to get the unique carrier generated number. Additionally, while some carriers have now introduced the ability to obtain a unique carrier generated number over the internet which can be applied to the mailpiece by the sender, this approach has the downside of requiring the sender to be connected to the carrier's website via the internet whenever use of the track and trace service is required. Furthermore, in the web-based system just described, the carrier loses control of ensuring that a particular unique carrier generated number was actually affixed to a specific mailpiece.

Each of the aforementioned United States Patent Applications address one solution to some of the problems set forth above by having the sender provide on a mail item a unique sender generated identifier consisting of a unique number and an electronic address such as an e-mail address OF THE SENDER. This identifier can then be used by the carrier service to provide information to the e-mail address about, for example, the delivery of the mail item. The problem with this solution is that it relies on the sender generated unique number for tracking the mailpiece. Carriers may consider this to be unacceptable since they would have to rely on the quality of the sender generated unique number for tracking mail items through their system.

Accordingly, what is needed is a system and method that allows senders of a mail item to obtain track and trace and/or confirmation of delivery services without interfacing with the carrier service prior to submission of the mail item into the carrier distribution system. Further, the needed system should be capable of being implemented into existing carrier distribution systems with minimal modification and should be capable of creating a natural “translation” process linking unique user and carrier generated identifiers associated with a particular mailpiece.

### SUMMARY OF THE INVENTION

The instant invention provides an improved carrier distribution system having apparatus for reading a unique sender generated identifier from a mail item; structure for including a unique carrier generated identifier on the mail item; a data base that associates the unique sender generated identifier with the unique carrier generated identifier; at least one sensor that reads the unique carrier generated identifier from the mail item and provides location information to the data base that is associated with the unique carrier generated identifier so that at times when the carrier distribution system receives a location query from an entity about the mail item via submission of the unique sender generated identifier the location information is obtainable from the database without requiring submission of the unique carrier generated identifier by the entity.

The instant invention also includes a method for tracking through a carrier distribution system a mail item created by a sender. The method includes the steps of inducting the mail item into the carrier distribution system, the mail item having thereon a unique sender generated identifier; obtaining the unique sender generated identifier from the mail item during processing of the mail item in the carrier distribution system; assigning a unique carrier generated identifier to the mail item; associating the unique sender generated identifier with the unique carrier generated identifier; the carrier tracking the location of the mail item through the carrier distribution system using the unique carrier generated identifier; and allowing the sender to obtain location information about the mail item using the unique sender generated identifier without the sender having knowledge of the unique carrier generated identifier.

### BRIEF DESCRIPTION OF THE DRAWINGS

The accompanying drawings, which are incorporated in and constitute a part of the specification, illustrate a presently preferred embodiment of the invention, and together with the general description given above and the detailed description of the preferred embodiment given below, serve to explain the principles of the invention.

FIG. 1 shows a mail item used in the instant invention;

FIG. 2 is a schematic representation of the inventive carrier distribution system;

FIG. 3 shows an ID Tag printed on a mailpiece;

FIG. 4 is a flowchart describing the processing of a mail item within the carrier distribution system of FIG. 2; and

FIG. 5 shows a Status Monitoring Data Base.

### DETAILED DESCRIPTION OF THE PREFERRED EMBODIMENTS

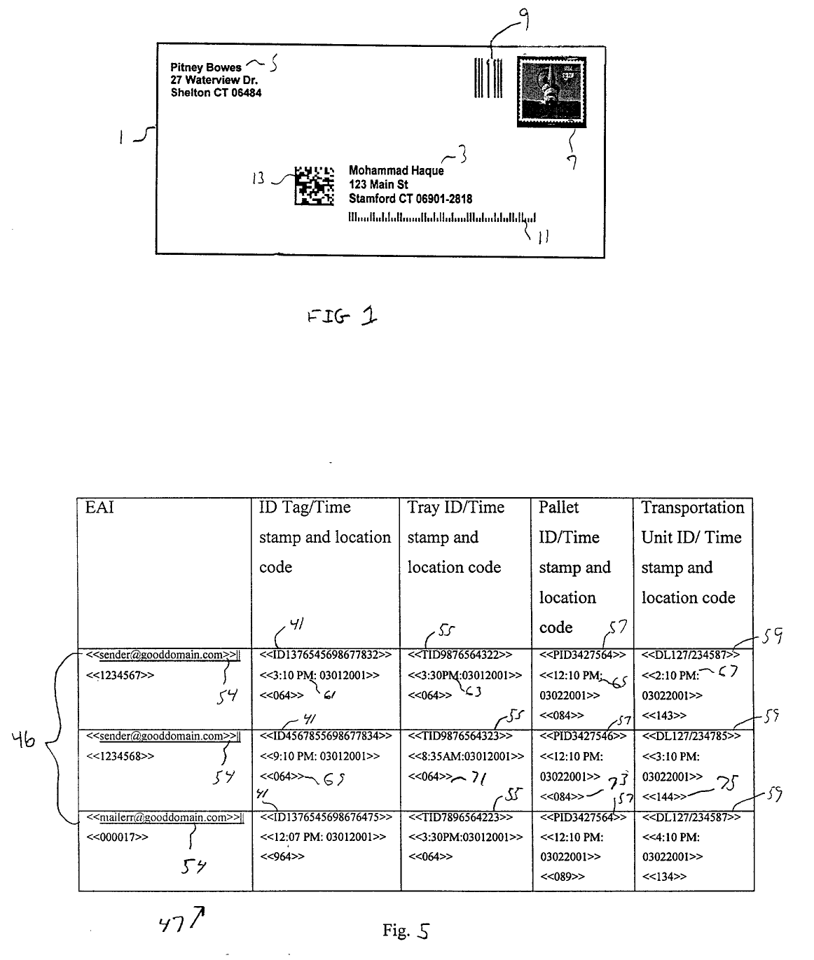

Referring to FIG. 1, a mail item 1 is shown having a recipient address 3, a return address 5, evidence of postage paid 7, a facing identification mark (FIM) 9, a postnet barcode 11, and an electronic address and identifier mark (EAIM) 13. The EAIM 13 can be, for example, the electronic address of the sender such as (<<sender@gooddomain.com>>) combined with a unique number <<1234567>>. This combination is a unique identification for the specific mail item 1. In this example, the unique combination [<<sender@gooddomain.com>>||<<1234567>>] is the unique identification for the item number 1234567 and is represented on the mail item 1 (in a reliable machine readable format, for example in one of the well known in the art linear or two dimensional bar codes (e.g. code 128 or DataMatrix.) as the EAIM 13. The unique identification information

[<<sender@gooddomain.com>>||<<1234567>>] is referred to herein as the Electronic Address and Identifier (EAI) and when represented on the mail item 1 in a machine-readable format becomes the EAIM 13.

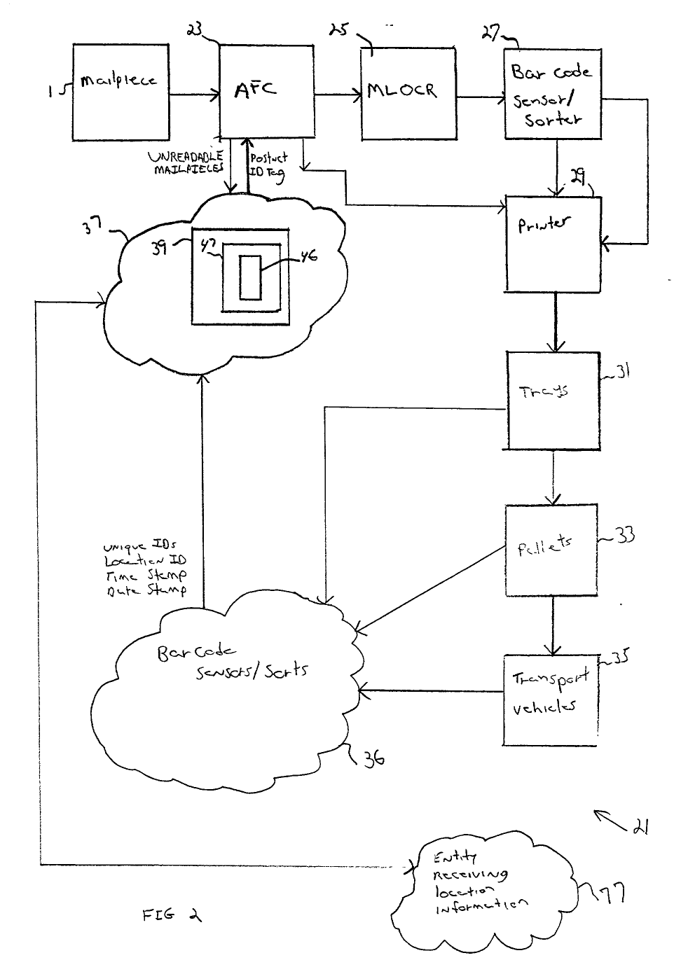

Referring to FIG. 2, implementation of the instant invention in a postal distribution system 21 is shown. In current postal systems when mailpieces are inducted into the delivery-processing network, they are sent to an advanced facer/canceler 23 (AFC). The AFC 23 performs two primary functions. First, it uses sensors to identify and determine on which side of each mailpiece the evidence of postage payment 7 (i.e. stamp, indicium, etc.) and the recipient address 3 are located. Once the location of the recipient address 3 has been identified, the AFC 23 faces (positions) the mailpiece in a proper orientation to allow for the subsequent machine processing of the mailpiece through the distribution network. Secondly, the AFC 23 prints a cancellation mark over the evidence of postage payment 7 if such evidence 7 is identified by the AFC 23 as being a stamp(s).

The AFC 23 also scans the recipient address 3 and sorts individual mailpieces into two categories. The first category are those that have a machine-readable address while the second category are those that have an address which cannot be read by a machine. The machine-readable pieces are processed to a multiple line optical character recognition (MLOCR) device 25 where the recipient address is read. At this point in time, if these mailpieces do not have a postnet barcode 11 printed thereon which is detected by a bar code sensor 27, one is applied at a bar code printer 29. All mailpieces are then processed for delivery in the conventional manner using the postnet barcode 11 for delivery sorting purposes. That is, based on the postnet barcode 11 the mailpieces are aggregated in trays 31 for delivery to common delivery distribution points. The trays 31 are placed on pallets 33 and the pallets 33 aggregated on transportation vehicles 35 (collectively refereed to as mail item receptacles). Upon delivery to individual distribution points, additional bar code sensors 36 are used to sort these mailpieces down to an even further level until they are ultimately delivered to the recipient. There are also unique numbers assigned by the carrier to the trays 31, pallets 33, and transportation vehicles 35 which are used for tracking those mail item receptacles through the distribution network.

Returning to the unreadable mailpieces, the AFC 23 is equipped with the capability to capture a digital image of these mailpieces. These images are sent to a location 37 (which may or may not be remotely located from the AFCS 23) where an operator views the image and determines the address and associated postnet barcode. The operator enters this data into a database 39 using a processing computer and the processing computer assigns a unique identification tag (ID Tag) which is linked to the mailpiece image in the database 39. The computer provides the AFCS 23 with the ID Tag and the postnet barcode 11 for the mailpiece. The AFCS 23 interfaces with the barcode printer 29 in a conventional manner to effectuate printing of the ID Tag and the postnet barcode 11 on the mailpiece.

FIG. 3 shows the back of the mailpiece having an ID Tag 41 applied thereto. Once printing of the ID tag 41 and the postnet barcode 11 on the mailpiece is accomplished, the previously identified unreadable mailpieces are placed in trays 31, pallets 33, and transportation vehicles 35 together with other mailpieces for further processing as described above in connection with the readable mailpieces. The ID tag 41 is presently not used for any type of track and trace service but simply provides a link between the unreadable mailpiece image and the unreadable mailpiece itself.

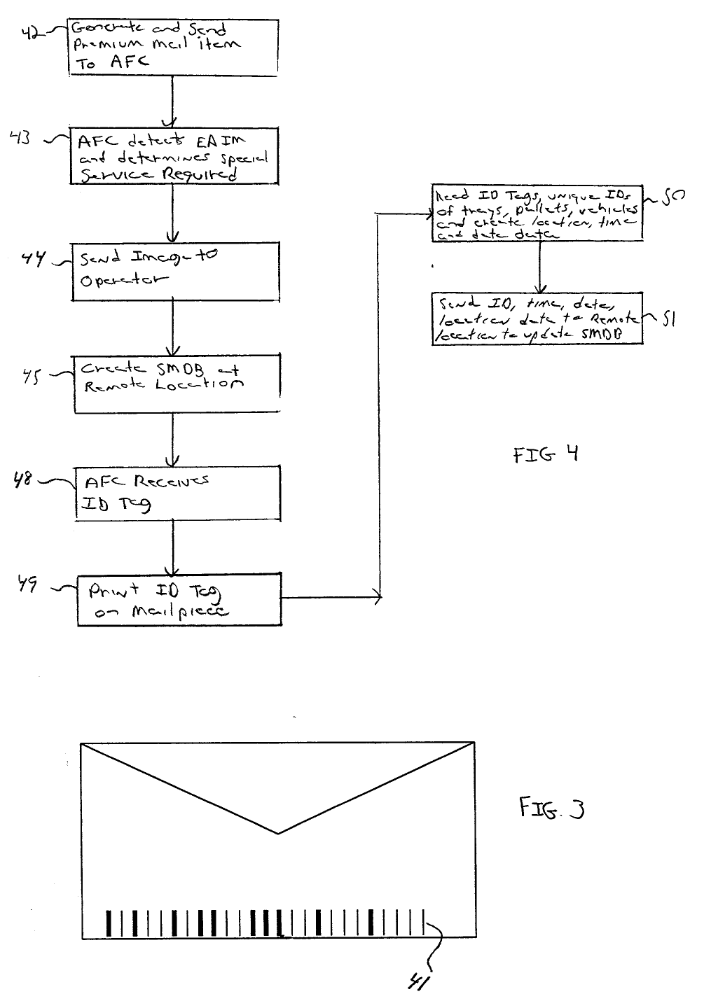

The postal distribution system 21 of the present invention takes full advantage of the existing AFC 23 and ID Tag 41 generation functionality. That is, the AFC 23 and ID tag 41 generation apparatus modules are modified as discussed below to be used for track and trace and/or confirmation delivery services since the ID Tag 41 is a unique carrier generated identifier. Specifically, referring to FIGS. 2 and 4, when a premium mail item 1 which requires electronic confirmation and/or track and trace service is sent to the AFC 23 (step 42), the AFC 23 (which has been modified in accordance with the present invention) determines that the mail item 1 requires such special processing by detecting the EAIM 13 on the face of the mail item 1 (step 43). When the AFC 23 determines that the mail item 1 requires electronic confirmation and/or track and trace services, it sends the image of the mail item 1 to the processing computer 37 (step 44). The computer 37 creates (or obtains) the ID Tag 41 for the mail item 1 and also creates a record 46 in the data base 39. The record 46 includes the EAI of the mail item 1 together with its ID Tag 41 and, if desired, its electronic image. The EAI is obtained from reading the EAIM off the mailpiece at the AFC 23 or from the electronic image at the operator location 37 These premium service records 46 form their own data base 47 referred to herein as a Status Monitoring Data Base or SMDB (step 45). The AFC 23 receives the ID Tag 41 (step 48) which it imprints through bar code printer 29 on the item 11 (step 49). The instant invention recognizes that the unique ID Tag 41 can be used in all subsequent steps in the processing and delivery of the mail item 1 That is, wherever there are bar code sensors 29 within the postal distribution system, the ID Tag 41 can be detected and its location determined.

The SMDB 47 contains, in addition to the EAI, electronic image, and ID Tag 41, time stamps and identity information for locations for different important events (arrivals and departures of the mail item 1 to and from different facilities and change of control over the item) as well as time stamps and locations of mail item 1 during regularly scheduled data captures. All of this data capture is made possible by detecting the ID tag 41 at any location having a bar code sensor 29 (such additional bar code sensors are shown collectively at 36 for the sake of simplicity of explanation).

It is important to emphasize that currently, capturing data directly from the mail item 1 is normally possible only at the very beginning and very end of the processing cycle when mail item is not grouped and packaged together with other items. However, the instant invention recognizes that when the mail item 1 is a part of a group physically located within a tray 31, pallet 33, or transportation vehicle 35 or other receptacle, the mail item 1 record 46 is amended to include the identity of the specific mail item receptacle in which it has been placed for delivery. This allows trace location of the mail item 1 through the entire postal processing cycle even where individual mailpieces 1 are not being handled since the location of the corresponding mail item receptacles are tracked via their unique numbers which are typically contained in a barcoded labels placed thereon. That is, as the mail item 1 or other receptacles are processed by any one of the sensors 36 the ID tags are read and corresponding location, date, and time data are created (step 50). The sensors send the location time, date, and location data to the location 37 where the SMDB 47 is continuously updated during mail item 1 processing by adding a time stamp, a date stamp, and the location of the mail item 1 itself or receptacle in which it is contained based on the received data (step 51). From this viewpoint, any means of transportation used by postal operators (trucks, railroad cars or aircrafts) can be viewed as receptacles with a specific identity.

An example of an SMDB 47 is shown in FIG. 5. The SMBD 47 includes the individual data records 46 consisting of individual mailpiece 1 EAI's 54, as well as ID Tag 41, and tray 31, pallet 33 and transportation vehicle 35 ID's 55, 57, and 59. The SMBD 47 is a dynamic data base which is continuously updated as the mail item 1 is being processed through the postal system distribution system 21. At each step along the way the mail piece 1 or receptacle identity is captured, and the records 46 are supplemented with time 61, 63, 65, and 67 stamps, and location stamps 69, 71, 73, and 75 These updates are electronically sent to (preferably) a centrally maintained SMDB 47. SMDB 47 can be maintained on a central server connected through a public communication network (e.g. Internet) to all data capture terminals (27, 36). In practice the data capture terminals (27,36) can be stand-alone bar code readers or a portable PC with attached bar code scanner. The terminals can be connected to the public communication network through a wired or wireless connection depending on the cost and convenience required. Moreover, the system can be implemented as a private network. These arrangements are well known in the art. Thus, the SMDB 47 contains all required information for tracing lost items as well as other possible inquiries concerning the mail item 1 status that can be made by senders, recipients, and postal employees (collectively referred to in FIG. 2 as entity 77).

As discussed above, the AFC 23 can also be retrofitted to not only detect but also to read the contents of the EAIM 13 to capture EAI information from the mail item 1. This captured information can automatically be used to send an electronic confirmation to the sender, such as for example, by using e-mail. This step can be made particularly effective if the EAIM 13 is imprinted within the destination address block 3, for example, left of it as depicted in FIG. 1. This arrangement has three significant advantages. First, the destination address block 3 must be examined by the AFC 23 anyway as discussed above. Thus, finding and interpreting the EAIM 13 when it is present within the address block 3 is easier than when the EAIM 13 is elsewhere. Second, the EAIM 13 printing can be simplified if it is imprinted on the destination address-bearing document and made visible through a window in the envelope. This allows creation and printing of all required information on a document or a standard form avoiding separate printing or affixng of labels to the envelope. Third, the EAIM 13 can be formatted in such a way that its size is indicative of the vertical size of the destination address block 3 (this can be done for example by manipulating vertical dimension of modules in two-dimensional bar codes). In this manner the EAIM 13 block becomes a destination address block 3 locator mark if it is present left or right of the address. Because a two-dimensional bar code representation for the EAIM 13 is highly distinguishable from regular text, it makes finding and parsing the destination address block 3 much easier. Note, that if the EAIM 13 is represented in a linear bar code it can also be formatted and printed as an address block 3 locator For example, the EAIM 13 can be divided into 2 parts one of which can be vertically oriented and have a size of the vertical dimension of the address block, while the other can be horizontally oriented and have a size of the horizontal dimension of the address block 3.

As has been clearly demonstrated above, the SMBD 47 links the unique sender generated EAIM 13 with the unique carrier generated ID Tag 41. Accordingly, the sender can always check the status of or automatically receive information about the mailpiece 1 simply by knowing the user generated EAI information while the carrier can track the mailpiece 1 by relying on the carrier generated ID Tag 41. Thus, the instant invention provides the following benefits;

1—The sender no longer has to interface with the carrier in advance to obtain a pre-assigned carrier tracking number that must be placed on the mailpiece. This eliminates either the personal delivery of the mail item 1 to the carrier by the sender or the need to interface online prior to submitting the mail item 1 into the carrier's distribution system.

2.—The sender can now generate a premium service mailpiece 1 independent of the carrier and simply deposit it into any carrier receptacle (i.e. street letterbox) and still be assured of obtaining the benefit of the premium service.

3.—The use of a unique carrier generated ID Tag 41 avoids the expensive and inefficient process of preprinting specialized labels that typically use linear barcodes containing unique non-overlapping numbers that must be distributed to the senders prior to mailing. (Otherwise, if the mailers create these unique identification numbers the carrier can not guarantee that they will be unique. Another problem with these specialized labels is that they are often not precisely located on the surface of the mailpiece and thus require special handling in order to be read.

4.—The system of present invention allows use of internal postal ID tags 41 as they have been already defined without any involvement of customers. These postal ID tags 41 can be easily read by existing equipment already designed for processing bar codes. Moreover, the changes required at the AFCS 23, the addition of bar code readers at various points in the carrier distribution system to read the ID tags 41 and/or the EAIM 13, and the generation of the SMDB 47 to link all of the information together requires a minimal amount of modification to the existing postal distribution infrastructure.

The present invention also leverages the use of the commonly referred to Carrier Sequence Bar Code Sorters (CSBCS) for the purpose of facilitation of electronic confirmation of delivery. Typically, mailers (senders) want to know that their mail items have been delivered into recipient's mailbox. Such service is difficult to organize effectively and at low cost since most mail carriers do not use any equipment and essentially utilize manual processes. However, most mailers would be very satisfied if they would have assurances that their mail reached the postal delivery office nearest to its final destination mailbox. The reason for this is that the chances that mail will be lost during the final delivery process (sometimes called last mile process) are fairly small taking into account the generally established reliability of the postal service. Thus, when the mail arrives at the delivery office it would be quite sufficient for the mailer to receive confirmation of this event for most purposes.

Currently, when letter mail arrives at the delivery office it is more and more frequently processed by a CSBCS. The CSBCS takes mail already sorted to the carrier route level and sorts it for final delivery, stop by stop. In the USA the process takes several thousands mail items (letters) and sorts them into a sequence of several hundreds stops. The CSBCS is equipped with an imaging system to capture bar coded postal delivery codes. The imaging system of the CSBCS can be modified to capture the digital image of the mail item 1 and ID tags 41 as they are described above. In this case the CSBCS with a modified imaging system can automatically capture the image of the mail item 1, find and interpret the EAIM 13 and send a required electronic confirmation to the original sender based using the e-mail address in the EAM 13. Importantly, all these procedures can be executed automatically during the CSBCS mail sorting process. In addition, the CSBCS can interpret ID tags 41 and store ID tag 41 information together with the digital image of mail item 1 requiring electronic confirmation of delivery. In this fashion, if the mail item 1 occasionally gets lost during final delivery and the mailer learns from his/her correspondent about its non-delivery, the fact of arrival of the mail item 1 into delivery office can be easily established. This information is useful in finding the reasons for nondelivery and the ultimate recovery of the item. Stored images together with the ID tags 41 can be discarded after a pre-specified period of time, for example 3 days, thus reducing the cost of the storage. The storing of this data can be done locally or included in the SMDB 47 as discussed above.

Additional advantages and modifications will readily occur to those skilled in the art. Therefore, the invention in its broader aspects is not limited to the specific details and representative devices, shown and described herein. Accordingly, various modifications may be made without departing from the spirit or scope of the general inventive concept as defined by the appended claims. Such modifications may include for example:

1—While a specific postal carrier distribution system is shown, the inventive concepts can be incorporated in any carrier distribution system.

2—The unique sender generated identifier (EAIM) can be created by a postage meter which has been modified to include that functionality upon a user selection of a premium service.

3—The unique sender generated identifier has been shown as including an electronic address and a unique number. However, the unique sender generated identifier could simply be a unique number or any other unique identifier.

4—Application of the EAIM 13 and ID Tag 41 can be made directly on the mailpiece 1 or on labels that are subsequently placed on the labels. Moreover, means for applying the EAIM 13 and/or ID Tag 41 can be a printer or any other marking mechanism or information retaining device (such as an IC chip) which can be applied to the mail item 11 and be read.

5—The EAIM 13 can include other types of electronic addresses in addition to an e-mail address. For example, the electronic address can be a page number, a facsimile number, or a telephone number or any other type of address to which information can be sent electronically.

6—While an AFC 23 and convention bar code sensors/readers 27 have been shown, any devices that are capable of detecting and reading the EAIM 13 and the ID Tag 41 can be used as well.

7—The operator remote location 37 would include computer processing capability that would interface via a network with the data base 39 and the rest of the data gathering elements of the carrier distribution system 21 in order to facilitate the updates to the files 46 of the SMDB 47.

What is claimed is:

1. A method for tracking through a carrier distribution system a mail item created by a sender, the method comprising the steps of:
inducting the mail item into the carrier distribution system, the mail item having thereon a unique sender generated identifier;
obtaining the unique sender generated identifier from the mail item during processing of the mail item in the carrier distribution system;
assigning a unique carrier generated identifier to the mail item;
associating the unique sender generated identifier with the unique carrier generated identifier;
the carrier tracking the location of the mail item through the carrier distribution system using the unique carrier generated identifier; and
allowing the sender to obtain location information about the mail item using the unique sender generated identifier without the sender having knowledge of the unique carrier generated identifier.

2. The method as recited in claim 1, further comprising applying the unique carrier generated identifier to the mail item.

3. The method as recited in claim 2, further comprising applying the unique carrier generated identifier in a bar code form.

4. The method as recited in claim 2, wherein the unique sender generated identifier is in a bar code form.

5. The method as recited in claim 4, wherein the mail item has a recipient address printed thereon and the unique sender generated identifier is located on the mail item proximate the recipient address and further comprising using the unique sender generated identifier for locating the recipient address.

6. The method as recited in claim 1, wherein the unique sender generated identifier includes an address and further comprising the carrier obtaining the address from the unique sender generated identifier and supplying to the address information about the location of the mail item.

7. The method as recited in claim 6, wherein the address is one of an e-mail address, a pager number, and a facsimile machine number.

8. The method as recited in claim 1, wherein the unique sender generated identifier includes an electronic address and additional data that uniquely identifies the mail item.

9. The method as recited in claim 1, further comprising uniquely associating the unique sender generated and unique carrier generated identifiers by storing them in a file.

10. The method as recited in claim 9, further comprising reading the unique carrier generated identifier at a plurality of locations throughout the carrier distribution system, storing in the file a date stamp, a time stamp, and a location identifier each time the reading of the unique carrier generated identifier occurs, and associating in the file the date stamp, time stamp, and location identifier with the unique carrier generated identifier and the unique sender generated identifier.

11. A carrier distribution system for tracking a mail item having a unique sender generated identifier thereon, the carrier distribution system comprising:
means for reading the unique sender generated identifier from the mail item;
means for including a unique carrier generated identifier on the mail item;
a data base that associates the unique sender generated identifier with the unique carrier generated identifier;
at least one sensor that reads the unique carrier generated identifier from the mail item and provides location information to the data base that is associated with the unique carrier generated identifier so that at times when the carrier distribution system receives a location query from an entity about the mail item via submission of the unique sender generated identifier the location information is obtainable from the database without requiring submission of the unique carrier generated identifier by the entity.

12. A system as recited in claim 11, wherein the means for reading is an automatic facer/canceler.

13. A system as recited in claim 12, wherein the unique carrier generated identifier is printed in a bar code form.

14. A system as recited in claim 12, wherein the unique sender generated identifier is in a bar code form.

15. A system as recited in claim 14, wherein the mail item has a recipient address printed thereon and the unique sender generated identifier is located on the mail item proximate the recipient address and the advanced facer/canceler detects the unique sender generated identifier and uses such detection for locating the recipient address.

16. A system as recited in claim 11, wherein the unique sender generated identifier includes an address and the means for reading obtains the address from the unique sender generated identifier and supplies to the address an indication that the mail item has been read at the means for reading.

17. A system as recited in claim 16, wherein the address is one of an e-mail address, a pager number, and a facsimile machine number.

18. A system as recited in claim 11, wherein the unique sender generated identifier includes an electronic address and additional data that uniquely identifies the mail item.

19. A system as recited in claim 11, wherein the location information includes a date stamp, a time stamp, and a location identifier.

20. A system as recited in claim 11, wherein the unique sender generated identifier includes an indication of the type of premium service that is requested for the mail item.

21. A system as recited in claim 20, wherein the means for including is a printer.
